(19) United States
(12) Patent Application Publication
(10) Pub. No.: US 2023/0360094 A1
(43) Pub. Date: Nov. 9, 2023

(54) AI-POWERED USER-CENTRIC REVIEW SYSTEM

(71) Applicant: eBay Inc., San Jose, CA (US)

(72) Inventors: Biwei Jiang, Shanghai (CN); Wei Liu, Shanghai (CN); Xiangyu Wang, Shanghai (CN); Liangqi Pan, Shanghai (CN); Fei Dong, Shanghai (CN)

(21) Appl. No.: 17/738,308

(22) Filed: May 6, 2022

(51) Int. Cl. G06Q 30/02; G06F 3/0482; G06F 40/40; G06Q 30/06

(52) U.S. Cl. CPC G06Q 30/0282; G06F 3/0482; G06F 40/40; G06Q 30/0625

(57) ABSTRACT

A method of displaying a user interface is provided. The method includes retrieving reviews for an item and extracting indicia from the retrieved reviews. A first question is generated based on the extracted indicia. A first interactive user interface is displayed that includes the first question along with an option to provide a response that corresponds to a review of the item. A second question and an answer to the second question are generated based on the response to the first question. A second interactive user interface that includes the second question and the answer to the second question is then displayed.

### TECHNICAL FIELD

Examples of the present disclosure relate generally to machine learning techniques and, more particularly, but not by way of limitation, to machine learning techniques that can be used to provide an output to a user.

### BACKGROUND

When a user desires to purchase an item, reviews are helpful with assisting the user to decide whether to purchase the item. However, reviews that are available can be thin on information and painted with a broad stroke that may not necessarily be helpful to the user. For example, an item may have a five-star rating with a comment such as, “This product is great!” Reviews may be thin on information because providing a review is time consuming such that those who purchased the item are unwilling to provide a review. A reviewer may broadly rate the item as having five stars without providing any context or any discussion regarding why the reviewer rated the item as five stars. Furthermore, the reviewer may provide comments that are unique to them and not necessarily helpful to other users. For example, a user may indicate that a wearable item fits them very well or precisely tracks their progress during an exercise activity. However, the conditions under which the item performs well for the reviewer may be unique to the reviewer and not necessarily helpful to a user trying to determine if they should purchase the item.

### BRIEF DESCRIPTION OF THE DRAWINGS

Various ones of the appended drawings merely illustrate example examples of the present disclosure and should not be considered as limiting its scope.

FIG. 1 is a network diagram illustrating a network environment suitable for displaying an interactive user interface that includes item reviews, according to some examples.

FIG. 2 illustrates a method for generating and displaying an interactive user interface, according to some examples.

FIG. 3 is a user interface that displays first questions and an option to provide responses to the first questions, according to some examples.

FIGS. 4A and 4B illustrate a user interface that may be presented to a user, according to some example examples.

FIG. 5 illustrates a method for using a machine learning model to generate a question for an item based on reviews previously submitted for the item, according to some examples.

FIG. 6 is a block diagram illustrating architecture of software used to implement displaying an interactive user interface, according to some examples.

FIG. 7 shows a machine as an example computer system with instructions to cause the machine to implement displaying an interactive user interface, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

In some examples, a method of displaying an interactive user interface that includes item reviews is provided. In an example, reviews for an item are retrieved from a database. Using machine learning, indicia from the reviews are extracted and used to generate a first question. The first question can be displayed on a first interactive user interface that includes an option to provide a response associated with the first question. A second question and an answer to the second question is based on responses to the first question received at the first user interface. A second interactive user interface is generated that can be configured to display the second question and the answer to the second question.

In examples, the second interactive user interface can be displayed when a user decides to purchase an item. In addition to listing the second question and the answer to the second question, the second interactive user interface can include selectors that allow the user to interact with the second question. An example interaction can include providing a positive or negative vote for the second question. Moreover, the second interactive user interface can include a data array that graphically displays a rating for a feature of an item in response to a user interacting with the data array. In an example, the user can hover over the data array in order to graphically display information associated with the data array.

As will be detailed further on, techniques described herein provide a specific improvement over prior systems, such as systems that assist users with deciding whether or not to obtain an item. The specific improvement results in an improved user interface for electronic devices that allows users to determine whether or not to obtain an item. Additionally, the described techniques provide a particular manner of summarizing and presenting information in electronic devices by providing a first question and the ability to provide a response to the first question. Responses to the first question input at the user interface cause a second user interface to be displayed that summarizes the response received to the first question, without using conventional user interface methods such as displaying a generic index on a computer. Specifically, the summarization is provided in an interactive manner where the summarization dynamically changes in response to inputs received at the second user interface. Thus, in examples, inputs received at a first interface cause the generation of a second user interface based on the inputs received at the first user interface. Furthermore, inputs received at the user interfaces described herein cause a processing device to perform actions related to the inputs received at the user interfaces.

To further illustrate an implementation of an example, a user may desire to purchase a laptop computer. However, the user may decide that they would like additional information relating to the laptop computer prior to purchasing the laptop computer. In an example, once the user selects the laptop computer, an item page in the form of a user interface for the laptop computer is displayed to the user that includes an interactive user interface. The interactive user interface can include item information, such as a battery life of the laptop computer or a memory size of a graphics card of the laptop computer, that the user can consider in deciding to purchase the laptop computer.

Examples relate to processes used to gather and display the item information provided on the interactive user interface at the user interface. In an example, reviews from different databases, such as a database associated with a seller of the laptop computer and databases associated with third parties also selling the laptop computer, are retrieved. In examples, third party databases can initially be used until reviews are saved in a local database. Once a threshold amount of reviews are saved, such as one hundred, the process becomes a closed loop where the local database is accessed for reviews. Using a machine learning model, indicia from the reviews are extracted. In examples, the indicia can relate to keywords, numbers, phrases, and text strings. As an illustration, a review can include the following “This laptop computer has a battery life of 8 hours when I play games! However, the resolution when I play games is mediocre.” In an example, a machine learning model can determine that the indicia are the keywords “battery” and “life” along with a numerical value of “8” associated with the keywords. Additionally, a machine learning model can determine that the indicia are “graphics,” “mediocre,” and “games.”

In particular, the retrieved reviews are provided to a machine learning model. A machine learning algorithm associated with the machine learning model can determine a frequency of the indicia appearing in the retrieved reviews and then compare the frequency with a threshold. To further illustrate, a machine learning model can compare each of the indicia relating to “battery,” “life,” and “8” with a threshold. In the illustration, if each of the indicia relating to “battery,” “life,” and “8” exceeds a threshold, such as appearing more than three times in a review, the machine learning model can extract the indicia relating to “battery,” “life,” and “8” from the reviews. In further examples, the machine learning model can compare each of the indicia relating to “battery,” “life,” and “8” with a threshold. In the illustration, if each of the indicia relating to “battery,” “life,” and “8” exceeds a threshold, such as appearing more than three times in retrieved reviews, the machine learning model can extract the indicia relating to “battery,” “life,” and “8” from the retrieved reviews. In further examples, a graph based model, such as textrank, can be used for text processing where in order to find relevant sentences in text and in keywords.

In examples, using the indicia extracted from the reviews, a first question can be generated and displayed on a first interactive user interface. To further illustrate, if indicia relating to “battery,” “life,” and “8” are extracted from laptop computer reviews, a question that can be generated is “Do you think the laptop computer efficiently uses the battery?” The question can be displayed at a first interactive user interface where, in an example, selectors are provided that enable a reviewer to rate the item in the context of the question. To further illustrate, if the reviewer feels that a laptop computer efficiently uses the battery, the reviewer can assign a high rating to the question “Do you think the laptop computer efficiently uses the battery?”

In addition, if indicia relating to “graphics,” “mediocre,” and “games,” are extracted, a question that can be generated is “Would you recommend this computer to play games?” The question can also be displayed at the first interactive user interface where, in an example, selectors are provided that enable a reviewer to rate item in the context of the this question. To further illustrate, if the reviewer feels that the laptop computer is not great for playing games, the reviewer can assign a low rating to the question “Would you recommend this computer to play games?”

Furthermore, in examples, the reviewer can provide a review at the first interactive user interface. Regarding the question “Do you think the laptop computer efficiently uses the battery?” the reviewer can provide the comment “While playing games on the laptop computer, the laptop computer shuts down all background processes, thus, preserving battery life and allowing me to play games for 8 hours with the battery before shutting off.” Regarding the question “Would you recommend this computer to play games?” the reviewer can provide the comment “The graphics card for this laptop computer only comes with 4 to 8 Gb depending on the model you get. Thus, the resolution while I play games is average at best.”

In examples, a second question can be generated along with an answer based on the responses received to the first questions. In the illustration above, the reviewer indicated that the battery life can last up to 8 hours when playing video games. Furthermore, the reviewer mentioned that since graphics cards for the laptop computer have memory in a range of 4 Gb to 8 Gb, the resolution of games is only mediocre. With these reviews, examples can generate the question “How long does the battery last?” along with an answer of 8+ hours. Moreover, in an example, the question “What is the memory size of the graphics card?” can be generated along with the answer of 4 to 8 Gb. In an example, these questions and answers can be displayed at a second interactive user interface, which can be a product page for the laptop computer.

In examples, the item information is provided on the interactive user interface based on reviews others have provided for the item. In the laptop computer example, the item information provided on the interactive user interface is based on reviews other purchasers of the laptop computer have provided.

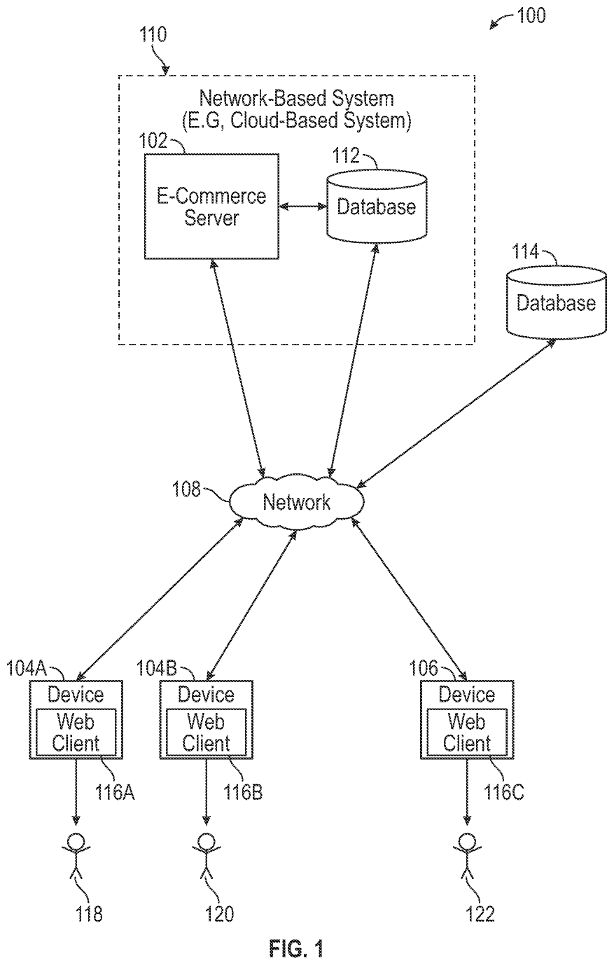

FIG. 1 is a network diagram illustrating a network environment 100 suitable for displaying an interactive user interface that includes item reviews implemented in a networked environment. The network environment 100 includes an e-commerce server 102, along with devices 104A, 104B, and 106 communicatively coupled to each other via a network 108. The devices 104A and 104B can be collectively referred to as “devices 104,” or generically referred to as a “device 104.” The e-commerce server 102 can be part of a network-based system 110 that includes a cloud-based database 112. In examples, the network-based system 110 can be affiliated with an entity that provides a platform for sellers to sell items. An example of an entity can be eBay™. In an example, the cloud-based database 112 can store reviews associated with items sold by sellers associated with the entity. Thus, in examples, the cloud-based database 112 can be accessed and the reviews can be retrieved. Examples of the cloud-based database 112 can include the Simple Storage Service offered by Amazon Web Services™, along with a SwiftStack™ object storage system.

In addition, the e-commerce system 102 can be communicatively coupled with a third-party cloud-based database 114 via the network 108, which can be publicly accessible. Examples of the third-party cloud-based database 114 can also include the Simple Storage Service offered by Amazon Web Services™, along with a SwiftStack™ object storage system. The third-party cloud-based database 114 can include databases used by third-party vendors not affiliated with the network-based system 110. Here, when the third-party vendors sell items, any reviews for the items sold by the third-party vendors are stored at the third-party cloud-based database 114. Moreover, the reviews stored at the third-party cloud-based database may be publicly retrieved by the e-commerce server 102 via the network 108.

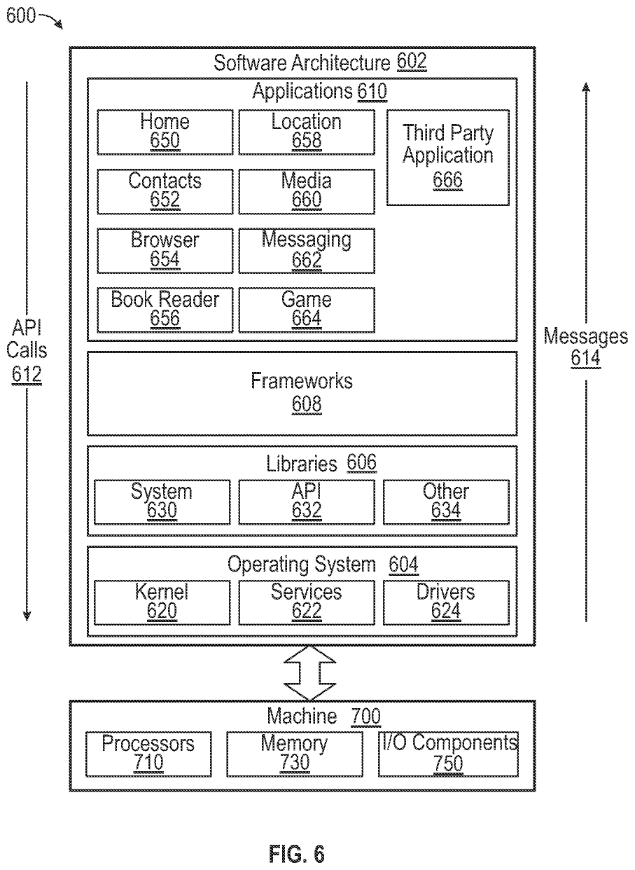

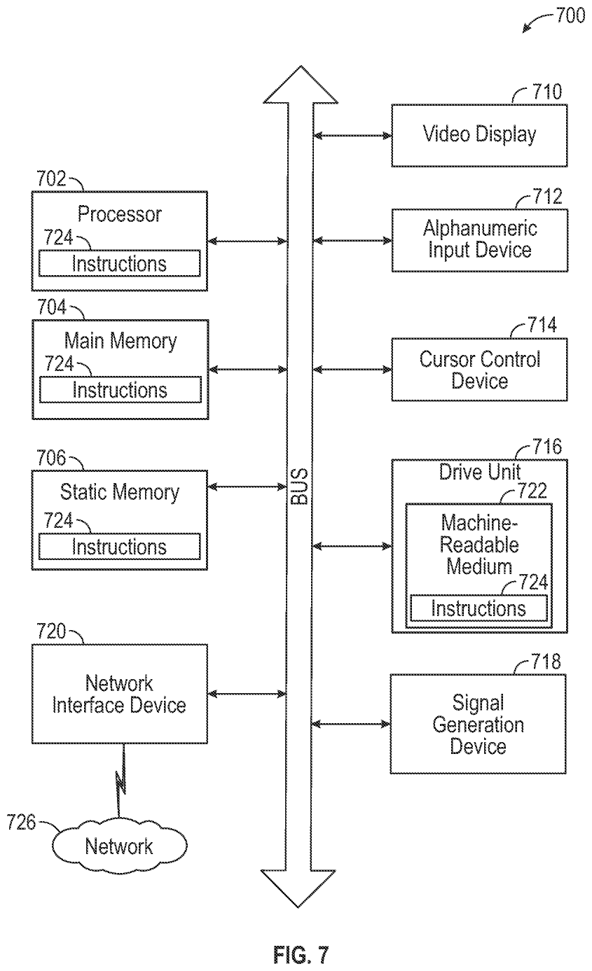

The devices 104 and 106 can interact with the e-commerce server 110 using web clients 116A-116C. The web clients 116A-116C can allow a user, such as users 118-122, to make a request and then show a result of the request. The e-commerce server 102 and the devices 104 and 106 can each be implemented in a computer system, in whole or in part, as described below with respect to FIGS. 6 and 7. The e-commerce server 102 provides an electronic commerce application to other machines (e.g., the devices 104 and 106) via the network 108. The electronic commerce application may provide a way for users to buy and sell items directly to each other, to buy from and sell to the electronic commerce application provider, or both.

To list an item for sale on the online marketplace, a seller can create a user account with the e-commerce server 102. The user account may include personal information (e.g., name, address, email address, phone number) and financial information (e.g., credit card information, bank account information) associated with the seller. Once the seller has created a user account, the seller can then use their user account to utilize the functionality of the e-commerce server 102, including listing an item for sale.

Also shown in FIG. 1 are the users 118-122 associated with the devices 104A, 104B, and 106. In some examples, each of the users 118-122 can be buyers of an item purchased through the network-based system 110 or a third-party vendor. The users 118-122 may be a human user (e.g., a human being), a machine user (e.g., a computer configured by a software program to interact with the devices 104 and 106 and the e-commerce server 102), or any suitable combination thereof (e.g., a human assisted by a machine or a machine supervised by a human). The users 118-122 are not part of the network environment 100 but are associated with the devices 104 and 106 and may be a user of the devices 104 and 106 (e.g., an owner of the devices 104 and 106). For example, the devices 104 and 106 may be a sensor, a desktop computer, a vehicle computer, a tablet computer, a navigational device, a portable media device, or a smart phone belonging to ones of the users 118-122. Moreover, the users 118-122 can be a buyer and/or a seller, where each of the buyer and the seller can be associated with any of the devices 104 and 106. Furthermore, the users 118-122 can be associated with a user account accessible by the electronic commerce application provided by the e-commerce server 102 via which the users 118-122 interact with the e-commerce server 102.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 6 and 7. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The network 108 may be any network that enables communication between or among machines, databases, and devices (e.g., the e-commerce server 102 and the devices 104 and 106). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

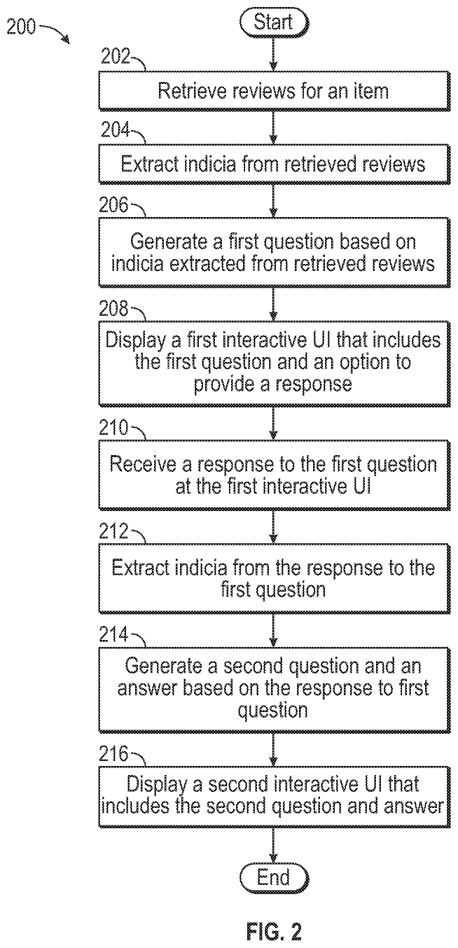

As noted above, examples relate to displaying an interactive user interface that includes item reviews. Now referring to FIG. 2, a method 200 for generating and displaying an interactive user interface is shown, in accordance with some examples. In some examples, the method 200 can be performed by the e-commerce server 102. Initially, in an operation 202, the method 200 retrieves reviews for an item. During the operation 202, reviews can be retrieved from a database associated with an entity selling the item. In particular, when the entity has sold the item in the past, the entity may receive reviews for the item. In examples, the reviews can be stored in a database associated with the entity, such as the cloud-based database 112 described above. During the operation 202, reviews can be retrieved from the cloud-based database 112. However, in some instances, the entity may not have sold enough of the items to receive any reviews, such as instances where ten examples of the item are sold and no buyer provides a review. In this instance, during the operation 202, reviews received by third-party entities, such as third-party vendors that can be other sellers not associated with the network-based system 110 (i.e., competitors to the entity associated with the network-based system 110), can be retrieved from a publicly accessible database associated with the other sellers, such as the third-party cloud-based database 114.

As an illustration of the method 200, herein referred to as the “laptop computer illustration,” during the operation 202, reviews for a laptop computer are retrieved from the third-party cloud-based database 114. In this illustration, the entity associated with the e-commerce server 102 has not sold enough of the laptop computers to receive reviews. Thus, in the illustration, the cloud-based database 112 does not include reviews for the laptop computer. Therefore, in the illustration, reviews for the laptop computer sold by a third-party vendor and stored in the third-party cloud-based database 114 are retrieved during the operation 202.

In the laptop computer illustration, the users 118 and 120 provided reviews of the laptop computer at the devices 104 via the web clients 116A and 116B. In the laptop computer illustration, the reviews from the users 118 and 120 are stored at the third-party cloud-based database 114 and are as follows:
First Review:
“I was able to play a game for 8 hours on one battery charge while I was traveling. The amount of hours the battery charge provides is amazing! However, even though I upgraded to the 8 Gb graphics card, the resolution when I play games is only mediocre.”
Second Review:
“I travel by train between Atlanta and Washington D.C., which can take up to 10 hours, without access to a power outlet. I am able to use this laptop computer during a 10-hour trip on one battery charge. I love the amount of battery charge! This laptop computer comes standard with a 4 Gb memory graphics card. When my child, who is seven, uses the laptop computer to play games, my child complains about the low resolution. However, my seven-year-old child has an easy time using the computer.”

After the method 200 retrieves reviews for the item during the operation 202, the method 200 performs an operation 204, where indicia can be extracted from the retrieved reviews. Examples of indicia can include keywords, numbers, phrases, text strings, or any other type of descriptor that describes the item. In examples, natural language processing (NLP) that employs a machine learning algorithm can be used to extract the indicia from the retrieved reviews. In some examples, NLP can employ representation learning and deep neural network-style machine learning methods to extract indicia from reviews during the operation 204. In examples, NLP can use text extraction that pulls pre-defined text from data. Text extraction can use a keyword extraction tool to recognize and extract relevant indicia, such as keywords and numerals. Methods for keyword extraction that can be used can include word frequency methods, word collocation, co-occurrence, term frequency-inverse document frequency (TF-IDF), Yet Another Keyword Extractor (YAKE!), or the like.

In some examples, indicia can be extracted based on a frequency with which the indicia appears in the reviews retrieved during the operation 202. During the operation 204, the frequency can be compared to a threshold and, based on the comparison, the indicia can be extracted from the retrieved reviews. In examples, TF-IDF techniques can be used to evaluate the relevance of indicia, such as a word, in a collection of reviews. Using TF-IDF techniques, this can be accomplished by determining the frequency with which indicia appears in a retrieved review and multiplying this frequency by an inverse retrieved review frequency of the indicia among different extracted reviews. Specifically, the number of times the indicia appears in a retrieved review is offset by the number of reviews that include the indicia. This can be done to eliminate the possibility of extracting terms such as “the,” “and,” “or,” and the like and instead focus on more relevant indicia, such as battery, memory, graphics, hours, and the like in the laptop computer illustration.

An illustration of comparing the frequency to a threshold is as follows, referred to herein as the frequency illustration. In the frequency illustration, during the operation 204, the indicia “graphics” may be found and extracted four times from a single review using TF-IDF techniques. In the frequency illustration, a threshold may be an indicia appearing three times in a review. Thus, if an indicia appears at least three times in a single review in the frequency illustration, the indicia should be extracted. In the frequency illustration, since “graphics” appears four times in a review, this exceeds the threshold of three. Thus, in the frequency illustration, the indicia “graphics” will be extracted. In further examples, the threshold can relate to the number of times the indicia appears in a plurality of extracted reviews instead of a single review.

Returning to the laptop computer illustration, during the operation 204, the method 200 uses a machine learning algorithm to extract indicia from the reviews retrieved from the third-party cloud-based database 114. In the first review, the reviewer commented that they are able to play games for 8 hours on one battery charge. The reviewer also commented that their laptop computer has the 8 Gb graphics card but the resolution when the reviewer plays games is only mediocre. Therefore, the machine learning algorithm extracts, as indicia, the keywords “battery,” “hours,” and “single charge” and the numeral “8” from the first review. Additionally, the machine learning algorithm extracts, as indicia, the keywords “graphics card,” “resolution,” “games,” “mediocre,” and “Gb,” and the numeral “8” from the first review.

In the second review, the reviewer stated that during ten-hour trips, their laptop computer lasts for ten hours on one battery charge. Moreover, in the second review, the reviewer commented that their laptop computer comes with a 4 Gb memory graphics card. According to the second review, when their child plays games on the laptop computer, their child complains about the low resolution. During the operation 204, the machine learning algorithm extracts, as indicia, the keywords “battery,” “hours,” and “one battery charge” along with the numeral “10” from the second review. Additionally, the machine learning algorithm extracts, as indicia, the keywords “memory graphics card,” “low resolution,” “games,” and “Gb,” and the numeral “4” from the second review. Moreover, the machine learning algorithm extracts, as indicia, the keywords “child,” “easy,” and the numeral “7.”

After completion of the operation 204, the method 200 performs an operation 206, where a first question is generated based on the indicia extracted from the retrieved reviews. In examples, the extracted indicia are reviewed and a first question is generated based on the extracted indicia. In particular, a relationship can be determined between the indicia and the item to which the indicia relate. Based on the relationship, a first question can be generated. In examples, the first question can be based on strengths and weaknesses determined from the retrieved reviews via the extracted indicia. Thus, if a strength, such as long battery life, is determined from the extracted indicia, the first question can relate to a battery life. Similarly, if a weakness, such as poor graphics, is determined from the extracted indicia, the first question can relate to graphics. It should be noted that even though the generation of only a single first question is being described, examples can relate to generating a first set of questions, where the set can include more than one question.

In some examples, NLP, which employs machine learning algorithms, can be used to generate the first question based on the indicia extracted from the retrieved reviews. In examples, transformer-based pretrained language models (T-PTLMs) can be used to generate first questions based on the indicia extracted from the retrieved reviews. T-PTLMs learn universal language representations from large volumes of text data using self-supervised learning and transfer this knowledge to downstream tasks. Moreover, T-PTLMs can be used to understand and produce human language. Examples of T-PTLMs that can be used can include named entity recognition, sentiment analysis, machine translation, text summarization, natural language generation, speech recognition, content moderation, automated question answering systems, or the like. Moreover, T-PTLMs can be obtained from the following open-source libraries/cloud services that provide pre-trained models accessible for NLP: CodeBERT (bidirectional encoder representations from transformers), hugging face transformers, OpenNMT (neural machine translation), embeddings from language models (ELMo), GPT-3, XLNet, and ULMfit. In examples, the downstream tasks can include generating a first question based on the indicia extracted from the retrieved reviews. In additional examples, other methodologies can be used to generate the first question based on the indicia extracted from the retrieved reviews.

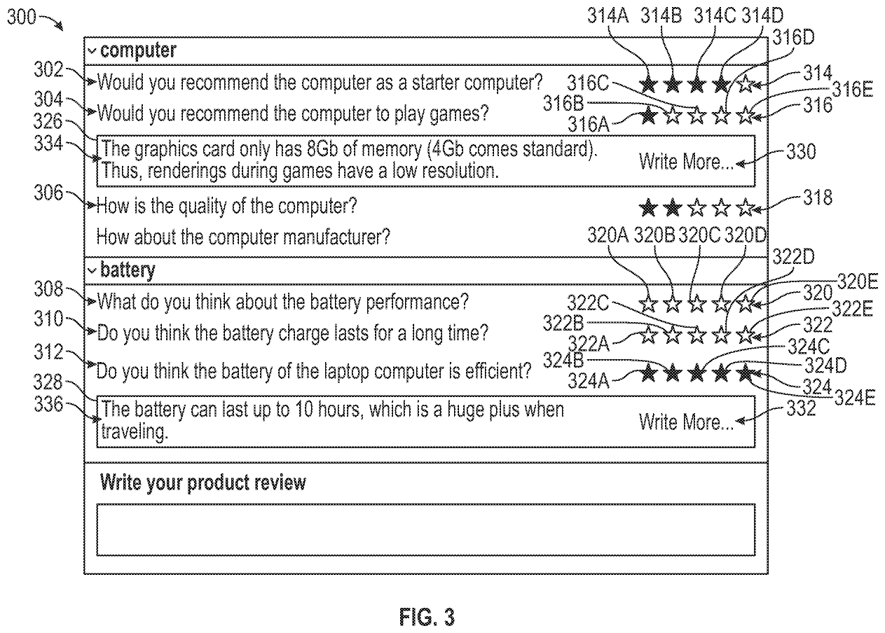

Upon generating a first question during the operation 206, the method 200 can display a first interactive user interface that includes the first question along with an option to provide a response to the first question during an operation 208. In an example, during the operation 208, a user interface 300 can be displayed that includes first questions 302-312, as shown with reference to FIG. 3. In examples, each of the first questions 302-312 can be generated based on indicia extracted from reviews as discussed above.

As noted above, the user interface that is displayed during the operation 208 can include the option to provide a response to the first question. In this regard, the user interface 300 can include an option for a user to provide a response to the first questions 302-312. In examples, the user interface 300 can include ratings 314-324 that respectively correspond to the first questions 302-312, as shown with reference to FIG. 3. The ratings 314-324 can be any type of indicia that allows a user to provide an input. In the example shown with reference to FIG. 3, the ratings 314-324 are shown as corresponding to stars, where a user may click on the stars to indicate a response to one of the first questions 302-312. However, the ratings 314-324 are not restricted to the configuration shown with reference to FIG. 3 and may include any other type of indicia that allows a user to provide an input, such as radio buttons, or the like.

Regardless of the configuration of the ratings 314-324, if a user agrees with one of the first questions 302-312, the user can select a number of stars that correlate to the agreement with the user. To further illustrate, the first question 304, “Would you recommend the computer to play games?” has indicia 316A-316E that correspond with the rating 316. Thus, if a user disagrees that they would recommend the computer to play games, the user can select the indicia 316A while not selecting the indicia 316B-316E, as shown with highlighting in FIG. 3. Alternatively, if a user strongly agrees with the first question 304, the user can select additional ones of the indicia 316B-316E in a manner that corresponds to a degree of the agreement the user feels with regards to the first question 304.

In addition to the ratings 314-324, the user interface 300 can also include comment sections 326 and 328 that allow a user to provide further comments regarding one of the first questions 302-312, as shown with reference to FIG. 3. In examples, the comment sections 326 and 328 can be accessed when a user engages one of selectors 330 or 332. Thus, in examples, if a user would like to provide further comments in response to the first question 304, the user can engage the selector 330, which can provide access to the comment section 326. It should be noted that the user can input comments into the comments section 326 or 328, or both. Furthermore, while the first questions 304 and 312 are shown as having the comments sections 326 and 328, each of the first questions 302-312 can include a selector that, when engaged by a user, provides a comment section similar to the comment sections 326 and 328, where a user can input comments related to one of the first questions 302-312.

To further describe the operations 206 and 208, returning to the laptop computer illustration, as noted above, indicia relating to the battery of the laptop computer, a single charge, the numerals “8” and “10,” and the hours were extracted. Therefore, during the operation 206, a first question that can be generated is the first question 308, which is “What do you think about the battery performance?” Moreover, another first question that can be generated is the first question 310, which is “Do you think the battery charge lasts for a long time?” Similarly, the first question 312 “Do you think the battery of the laptop computer is efficient?” can also be generated during the operation 206. In the laptop computer illustration, since the extracted indicia relate to a battery of the laptop computer, a single charge, and the hours, along with the numerals “8” and “10,” the first questions 308-312 can be generated relating to battery life of the laptop computer.

Moreover, in the laptop computer illustration, the indicia “memory graphics card,” “low resolution,” “games,” “mediocre,” and “Gb,” and the reference numeral “4” were extracted during the operation 204. Accordingly, during the operation 206, a first question that can be generated is the first question 302, which is “Would you recommend the computer as a starter computer?” Additionally, another first question that can be generated is the first question 304 “Would you recommend the computer to play games?” Furthermore, the first question 306 “How is quality of the computer?” can be generated during the operation 206. In the laptop computer illustration, since the extracted indicia also related to the memory graphics card of the laptop computer along with games, low resolution, mediocre, along with “Gb” and the numeral “4,” the first questions 302-306 are generated.

In the laptop computer illustration, during the operation 208, the user interface 300 is generated that includes the first questions 302-312, which were generated based on the reviews for the laptop computer retrieved during the operation 202. Furthermore, the comment sections 326 and 328 are generated during the operation 208, which allow a reviewer to input comments relating to the laptop computer when providing a review. It should be noted that while a set of first questions, such as the first questions 302-132, are described as being generated during the operation 206, in examples, a single first question can be generated instead of a set of first questions. To further illustrate, only one of the first questions 302-312, such as the first question 302, could be generated during the operation 206 and presented at the user interface 300 during the operation 208.

Returning to FIG. 2 and the method 200, after completion of the operation 208, an operation 210 can be performed where a response to the first question can be received at the first user interface. Returning to the laptop computer illustration, a reviewer who purchased the laptop computer agrees with the first question 302. Thus, the reviewer selects indicia 314A-D associated with the rating 314 during the operation 210. However, the reviewer disagrees with the first question 304 and selects indicia 316A associated with the rating 316 during the operation 210. Moreover, the reviewer inputs a comment 334 “The graphics card only has 8 Gb of memory (4 Gb comes standard). Thus, renderings during games have a low resolution.” at the comment section 326, as shown with reference to FIG. 3 during the operation 210.

Moreover, in the laptop computer illustration, during the operation 210, the reviewer agrees with the first question 312 and selects indicia 324A-E of the rating 324. In addition, the reviewer inputs a comment 336 “The battery can last up to 10 hours, which is a huge plus when traveling.” at the comment section 328, as shown with reference to FIG. 3, during the operation 210.

Returning to FIG. 2 and the method 200, using the responses received in the operation 210, the method 200 extracts indicia from the response to the first question in an operation 212. During the operation 212, indicia are extracted from the response in the same manner as indicia are extracted from the retrieved reviews during the operation 204, as disclosed herein.

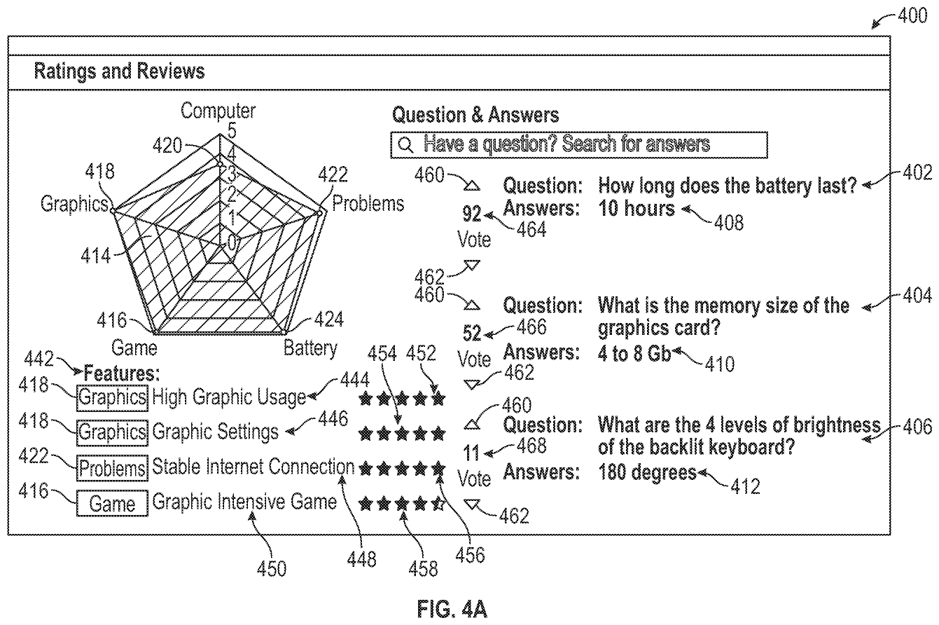

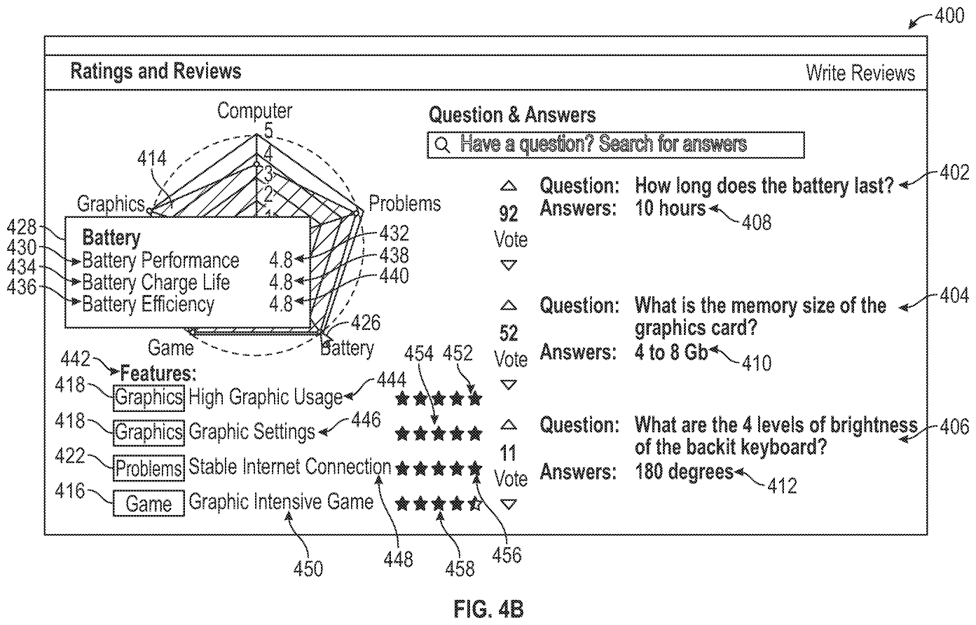

After the operation 212, the method 200 performs an operation 214 where the method 200 generates a second question and an answer to the second question based on the responses received in the operation 210 and the indicia extracted in the operation 212. In an example, T-PTLMs can be used to generate a second question and an answer to the second question based on a response to the first question along with the indicia extracted during the operation 214. After generating a second question and an answer to the second question during the operation 214, a second interactive user interface is displayed that includes the second question along with the answer to the second question during an operation 216. In an example, the user interface 400 can correspond to a product page for an item that is displayed to a user who is interested in purchasing the item to which the user interface 400 relates. In an example, during the operation 216, a user interface 400 can be generated that can include second questions 402-406 and answers 408-412 that can correspond to the second questions 402-406, as shown with reference to FIG. 4A. In examples, each of the second questions 402-406 along with the answers 408-412 can be generated using T-PTLMs on the responses received to the first questions 302-312 during the operation 214.

To further describe the operations 214 and 216, turning back to the laptop computer illustration, during the operation 214, T-PTLMs can be used to analyze the comment 334 “The graphics card only has 8 Gb of memory (4 Gb comes standard). Thus, renderings during games have a low resolution” and generate the second question 404 “What is the memory size of the graphics card?” as shown in FIG. 4A and the user interface 400. In examples, T-PTLMs can extract indicia such as graphics cards, memory, and 4 Gb and 8 Gb during the operation 212. In examples, T-PTLMs can determine that the comment relates to a graphics card having memory that is typically between 4 Gb and 8 Gb during the operation 214. Thus, T-PTLMs can generate the second question 404 “What is the memory size of the graphics card?” during the operation 214 based on the extracted indicia and the determination. In examples, the second question 404 “What is the memory size of the graphics card?” is displayed on the user interface 400 during the operation 216.

In the laptop computer illustration, the comment 334 also includes comments relating to the amount of memory, between 4 Gb and 8 Gb, the graphics card of the laptop computer has. Thus, T-PTLMs can be used determine that the answer 410 to the second question 404 is 4 to 8 Gb, which is also displayed on the user interface 400 during the operation 216.

During the operation 214, T-PTLMs can also be used to analyze the comment 336 “The battery can last up to 10 hours, which is a huge plus when traveling.” and generate the second question 402 “How long does the battery last?” as shown in FIG. 4A and the user interface 400. In examples, T-PTLMs can extract indicia such as battery, 10, and hours during the operation 212. In examples, T-PTLMs can be used to determine that the comment relates to a battery life of the laptop computer that can last up to ten hours during the operation 214. Thus, T-PTLMs can generate the second question 402 “How long does the battery last?” during the operation 214. In examples, the second question 402 “How long does the battery last?” is displayed on the user interface 400 during the operation 216.

In the laptop computer illustration, the comment 336 also includes comments relating to the amount of battery life, which is up to ten hours. Thus, T-PTLMs can be used to determine that the answer 408 to the second question 402 is ten hours, which is also displayed on the user interface 400 during the operation 216. Upon completion of the operation 216, the method 200 is complete. It should be noted that in accordance with examples, the operations 206-216 can be repeated multiple times in order to further refine questions that can be presented to reviewers. In particular, while the operations 206-216 are shown as being performed a single time, each of the operations 206-216 can be performed multiple times.

In further examples, the user interface 400 can be displayed on the user device 106 when the user 122 has an interest in purchasing an item, such as the laptop computer in the laptop computer illustration. In an example, the user interface 400 can correspond to a product page for the laptop computer. In examples, the user interface 404 can include an interactive data array 414 that can include keypoints 416-424. In examples, the keypoints 416-424 can correspond to various features of the item being viewed by the user 122. In the laptop computer illustration, the keypoints can correspond to various aspects associated with an item a user is contemplating purchasing. In the laptop computer illustration, the keypoints 416-424 can correspond to game (keypoint 416), graphic (keypoint 418), computer (keypoint 420), problems (keypoint 422), and battery (keypoint 424).

In an example, the interactive data array 414 can be configured to receive a user input at one of the keypoints 416-424 and display a rating associated with one of the keypoints 416-424 at which the user has provided the user input. To further illustrate, the user 122 may hover over the keypoint 424 that relates to a battery of the laptop computer as shown at 426 in FIG. 4B. In examples, when the user 122 hovers over the keypoint 424, a card 428 can be presented at the interactive data array 414, as shown with reference to FIG. 4B.

In examples, the card 428 can display ratings of various features associated with the item. In the laptop computer illustration, the features for a laptop computer can include the ability to run games (keypoint 416), graphics (keypoint 418), computer (keypoint 420), problems (keypoint 422), and battery (keypoint 424). The card 428 can show ratings for various attributes associated with a battery of the laptop computer. To further illustrate, the card 428 can show a battery performance attribute 430 that can correspond to what other users feel about the battery performance of the laptop computer, which is reflected in a rating 432. Moreover, the card 428 can show a battery charge life attribute 434 that can correspond to what other users feel about the longevity of the battery of the laptop computer, which is reflected in a rating 438. The card 428 can also show a battery efficiency attribute 438 that can correspond to what other users feel about the efficiency of the battery of the laptop computer, which can be shown in a rating 440.

In an example, the ratings 432, 438, and 440 are calculated using the ratings 320-324 discussed above. As discussed above, users can submit the ratings 320-324 via indicia 320A-320E, 322A-322E, and 324A-324E. Examples average the ratings provided via the indicia 320A-320E, 322A-322E, and 324A-324E and provide them as the ratings 432, 438, and 440. In an example, a machine learning algorithm, such as any type of neural network machine learning model, XGBoost, or this like, can be used to determine the ratings 432, 438, and 440. In some examples, the ratings 432, 438, and 440 can change over time based on different ratings provided at the user interface 300 and the indicia 320A-320E, 322A-322E, and 324A-324E such that the ratings 432, 438, and 440 can be dynamic. While not illustrated, cards similar to the card 428 can be displayed in the user interface 400 when a user hovers over one of the keypoints 416-422. The similar cards can also have the same features, such as the attributes 430, 434, and 436, along with the corresponding ratings 432, 438, and 440. In some examples, the attributes 430, 434, and 436 can be listed according to the ratings 432, 438, and 440. In particular, the attributes having the highest ratings can be displayed on the card 428. In this example, if an attribute had a rating higher than 4.8, this attribute can be listed on the card 428 based on this rating at the top.

Returning attention to FIG. 4A, the user interface 400 can also display a features area 442 that lists features 444-450 that can be associated with each of the keypoints 416-424. The features 444-450 can be the indicia extracted during the operations 204 and 212 described above. In an example, the features 444-450 are listed based on a frequency with which the indicia appear in the reviews retrieved during the operations 202 and 212. In particular, the TF-IDF techniques discussed above can be used to determine the features 444-450. To further illustrate, in the laptop computer illustration, using TD-IDF techniques, a determination can be made that the feature 444, which corresponds to “high graphic usage,” the feature 446, which corresponds to “graphic settings,” the feature 448, which corresponds to “stable internet connection,” and the feature 450, which corresponds to “graphic intensive game,” have been used the most in reviews provided by reviewers of the laptop computer. Thus, the terms “high graphic usage,” “graphic settings,” “stable internet connection,” and “graphic intensive game,” which correspond to the features 444-450, are listed in the features area 442 of the user interface 400.

The feature 444 can include a rating 452 while the feature 446 can include a rating 454. In addition, the feature 448 can include a rating 456 and the feature 450 can include a rating 458. In an example, the ratings 452-458 can be calculated based on ratings provided by a user while providing reviews for the laptop computer. More specifically, users can provide ratings similar to the ratings 320-324 via indicia 320A-320E, 322A-322E, and 324A-324E. Moreover, similar to how the ratings 432, 436, and 440 are determined, the ratings provided by the users can be averaged to provide the ratings 452-458. In an example, features having the highest average ratings are provided on the user interface 400 at the features area 442. In an example, a machine learning algorithm, such as any type of neural network machine learning model, XGBoost, or the like, an be used to determine which of the features 444-450 have the highest ratings. It should be noted that the features 444-450 are dynamic and can change based on indicia that are extracted from reviews and responses submitted at a later time.

As noted above, the user interface 400 can list the second questions 402-406 along with the answers 408-412. In examples, the second questions 402-406 and the answers 408-412 can be presented on the user interface 400 based on how useful users interacting with the user interface 400 found the second questions 402-406 and the answers 408-412. In particular, the user interface 400 can include selectors 460 and 462, which, in an example, can correspond to an up arrow, such as the selector 460, and a down arrow, such as the selector 462. If a user finds one of the second questions 402-406 and the accompanying one of the answers 408-412 useful in assisting with a determination to purchase the item, the user can vote up one of the second questions 402-406 and the accompanying one of the answers 408-412 via one of the selectors 460. Similarly, if a user finds one of the second questions 402-406 and the accompanying one of the answers 408-412 not useful in assisting with a determination to purchase the item, the user can vote down one of the second questions 402-406 and the accompanying one of the answers 408-412 via one of the selectors 462.

To further illustrate, in the laptop computer illustration, if a user finds the second question 402 “How long does the battery last” and the answer 408 “10 hours” useful in determining whether or not to purchase the laptop computer, the user can engage the selector 460 to indicate that the second question 402 and the answer 408 were useful. In addition, if the user 122 did not find the second question 404 “What is the memory size of the graphics card?” and the answer 410 useful, the user can engage the selector 462 to indicate that the second question 404 and the answer 410 are not useful.

When a user up votes or down votes one of the second questions 402-406 and the accompanying one of the answers 408-412, values associated with vote counters 464-468 can be incremented or decreased. In an example, when a user up votes the second question 402 and the answer 408, such as by engaging the selector 460, a value associated with the vote counter 464, such as the number 92, is incremented. In addition, when a user down votes the second question 404 and the answer 410, such as by engaging the selector 462, a value associated with the vote counter 466, such as the number 52, is decreased. In examples, the second questions 402-406 and the accompanying answers 408-412 can be displayed based on the values associated with the vote counters 464-468 where, in examples, the second questions 402-406 and the accompanying answers having the highest values associated with their respective vote counters 464-468, are displayed. In examples, the vote counters 464-468 can correlate to a rating of the second questions 402-406 and the answers 408-412. In particular, the higher the value associated with the vote counters 464-468, the higher the rating associated with the question and the answer associated with the vote counter.

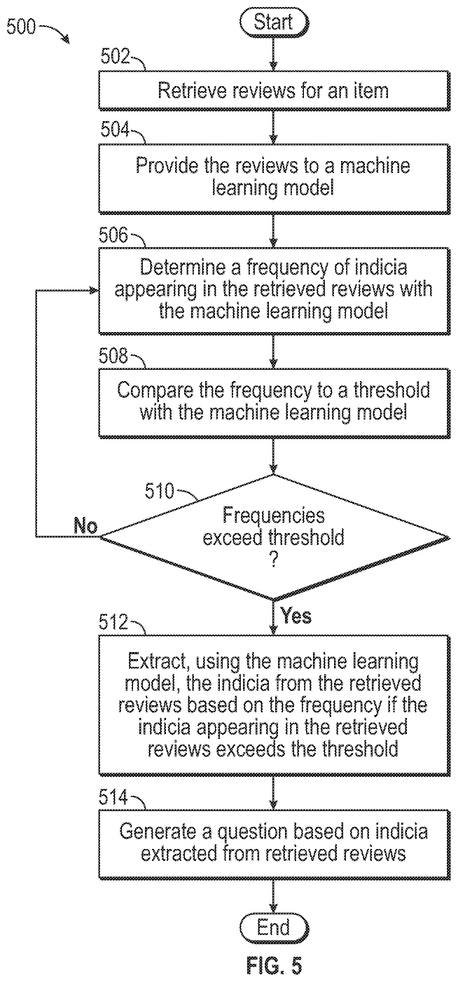

In a further example, a machine learning model can be used to generate a question for an item based on reviews previously submitted for the item. In this example, reviews are provided to a machine learning model, which can then be used to extract indicia from the reviews based on a threshold. To further illustrate this example, reference is now made to FIG. 5. A method 500 of generating a question based on review is shown, where, during an operation 502, reviews for an item are retrieved. During the operation 502, reviews can be retrieved from a database associated with an entity selling the item. In examples, the reviews can be stored in a database associated with the entity, such as the cloud-based database 112 described above. During the operation 502, reviews can be retrieved from the cloud-based database 112. However, in some instances, the entity may not have sold enough of the items to receive any reviews, such as instances where ten examples of the item are sold and no buyer provides a review. In this instance, during the operation 502, reviews received by third party entities, such as third-party vendors that can be other sellers not associated with the network based system 110 (i.e., competitors to the entity associated with the network based system 110) can be retrieved from a publicly accessible database associated with the other sellers, such as the third-party cloud-based database 114.

As an illustration of the method 500, reference will be made to the laptop computer illustration where the first review and the second review mentioned above are retrieved during the operation 502. Specifically, in the laptop computer illustration, reviews for a laptop computer are retrieved from the third-party cloud-based database 114 since the entity associated with the e-commerce server 102 has not sold enough of the laptop computers to receive reviews. Thus, in the laptop computer illustration, reviews for the laptop computer sold by a third-party vendor and stored in the third-party cloud-based database 114 are retrieved during the operation 502.

In the laptop computer illustration, the users 118 and 120 provided reviews of the laptop computer at the devices 104 via the web clients 116A and 116B. In the illustration, the reviews from the users 118 and 120 are stored at the third-party cloud-based database 114 and are as follows:
First Review:
“I was able to play a game for 8 hours on one battery charge while I was traveling. The amount of hours the battery charge provides is amazing! However, even though I upgraded to the 8 Gb graphics card, the resolution when I play games is only mediocre.”
Second Review:
“I travel by train between Atlanta and Washington D.C., which can take up to 10 hours, without access to a power outlet. I am able to use this laptop computer during a 10-hour trip on one battery charge. I love the amount of battery charge! This laptop computer comes standard with a 4 Gb memory graphics card. When my child, who is seven, uses the laptop computer to play games, my child complains about the low resolution. However, my seven-year-old child has an easy time using the computer.”

After reviews are retrieved during the operation 502, the reviews are provided to a machine learning model during an operation 504. An example machine learning model that can be used can include TF-IDF with the Python programming language. However, any machine learning model that enables indicia extraction and frequency calculation in accordance with the present disclosure can be used.

The machine learning model determines a frequency of indicia appearing in retrieved reviews during an operation 506 and then compares the frequency to a threshold in an operation 508 in order to determine if the frequency exceeds a threshold during an operation 510. In some examples, indicia can be extracted based on a frequency with which the indicia appears in the reviews retrieved during the operation 502. In examples, the frequency can relate to the number of times the indicia appears in the retrieved reviews. During the operation 506, the frequency of indicia appearing in a retrieved review can be determined with a machine learning model. In examples, TF-IDF techniques can be used to evaluate the relevance of indicia, such as a word, in a collection of reviews. Using TF-IDF techniques, this can be accomplished by determining the frequency with which indicia appears in a retrieved review and multiplying this frequency by an inverse retrieved review frequency of the indicia among different extracted reviews. Specifically, the number of times the indicia appears in a retrieved review is offset by the number of reviews that include the indicia. This can be done to eliminate the possibility of extracting terms such as “the,” “and,” “or,” and the like and instead focus on more relevant indicia.

Returning to the laptop computer illustration, during the operation 504, the first and second reviews are provided to a machine learning model. During the operation 506, the machine learning model determines the frequency of indicia appearing in the first and second reviews. In the first review, the reviewer commented that they are able to play games for 8 hours on one battery charge. Furthermore, in the first review, the reviewer commented that the amount of hours the battery charge provides is amazing. In the second review, the reviewer commented that they travel for ten hours and are able to use the computer for ten hours on one battery charge. Additionally, in the second review, the reviewer commented that they love the amount of amount battery charge. Thus, the indicia “battery charge” and “hour” can be gleaned from the first and second reviews by the machine learning model.

During the operation 506, the machine learning model determines that the indicia “battery charge” and “hour” appear twice in the first review and twice in the second review. Thus, the frequency of the term “battery charge” is four times. Similarly, the frequency of the term “hour” is four times. Moreover, in the laptop computer illustration, the frequency threshold is four. In the operation 508, the method 500 compares the frequency of the indicia “battery charge” appearing four times with the threshold of three and, in the operation 510, determines that the frequency of the indicia “battery charge” exceeds the threshold. In addition, in the operation 508, the method 500 compares the frequency of the indicia “hour” appearing four times with the threshold of three and, in the operation 510, determines that the frequency of the indicia “hour” exceeds the threshold.

After a determination is made that the frequency exceeds a threshold in the operation 510, the method 500 performs an operation 512, where the machine learning model extracts the indicia from the retrieved reviews based on the frequency of the indicia appearing in the retrieved reviews exceeding the threshold. Moreover, using the extracted indicia, the method generates a question based on the indicia extracted from the retrieved reviews during an operation 514.

Returning to the laptop computer illustration, during the operation 512, the machine learning model extracts the indicia “battery charge” and “hour” from the reviews retrieved during the operation 502 and generates the first question the first question 310, which is “Do you think that battery charge lasts for a long time?” using the techniques discussed above with reference to the operation 206 during the operation 514.

As noted above, during the operation 510, a determination is made regarding whether or not a frequency of indicia appearing in retrieved reviews exceeds a threshold. During the operation 510, if a determination is made that the frequency of indicia appearing in retrieved reviews does not exceed a threshold, the method 500 reverts back to the operation 506. Upon completion of the operation 514, the method 500 is complete.

FIG. 6 is a block diagram 600 illustrating a software architecture 602, which may be installed on any one or more of the devices described above. FIG. 7 is merely a non-limiting example of a software architecture, and it will be appreciated that many other architectures may be implemented to facilitate the functionality described herein. The software architecture 602 may be implemented by hardware such as a machine 700 of FIG. 13 that includes a processor 702, memory 704 and 706, and I/O components 710-714. In this example, the software architecture 602 may be conceptualized as a stack of layers where each layer may provide a particular functionality. For example, the software architecture 602 includes layers such as an operating system 604, libraries 606, frameworks 608, and applications 610. Operationally, the applications 610 invoke application programming interface (API) calls 612 through the software stack and receive messages 614 in response to the API calls 612, according to some implementations.

In various implementations, the operating system 604 manages hardware resources and provides common services. The operating system 604 includes, for example, a kernel 620, services 622, and drivers 624. The kernel 620 acts as an abstraction layer between the hardware and the other software layers in some implementations. For example, the kernel 620 provides memory management, processor management (e.g., scheduling), component management, networking, and security settings, among other functionality. The services 622 may provide other common services for the other software layers. The drivers 624 may be responsible for controlling or interfacing with the underlying hardware. For instance, the drivers 624 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 606 provide a low-level common infrastructure that may be utilized by the applications 610. The libraries 606 may include system libraries 630 (e.g., C standard library) that may provide functions such as memory allocation functions, string manipulation functions, mathematic functions, and the like. In addition, the libraries 606 may include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 may also include a wide variety of other libraries 634 to provide many other APIs to the applications 610.

The frameworks 608 provide a high-level common infrastructure that may be utilized by the applications 610, according to some implementations. For example, the frameworks 608 provide various graphic user interface (GUI) functions, high-level resource management, high-level location services, and so forth. The frameworks 608 may provide a broad spectrum of other APIs that may be utilized by the applications 610, some of which may be specific to a particular operating system or platform.

In an example, the applications 610 include a home application 650, a contacts application 652, a browser application 654, a book reader application 656, a location application 658, a media application 660, a messaging application 662, a game application 664, and a broad assortment of other applications such as a third-party application 666. According to some examples, the applications 610 are programs that execute functions defined in the programs. Various programming languages may be employed to create one or more of the applications 610, structured in a variety of manners, such as object-orientated programming languages (e.g., Objective-C, Java, or C++) or procedural programming languages (e.g., C or assembly language). In a specific example, the third-party application 666 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 666 may invoke the API calls 612 provided by the mobile operating system (e.g., the operating system 604) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 108 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 7 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device (cursor control device) 1314 (e.g., a mouse), a disk drive unit 716, a signal generation device 718 (e.g., a speaker) and a network interface device 720.

The drive unit 716 includes a machine-readable medium 722 on which is stored one or more sets of instructions and data structures (e.g., software) 1324 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. Instructions 724 may also reside within the static memory 706.

While the machine-readable medium 722 is shown in an example to be a single medium, the term “machine-readable medium” may include a single medium or multiple media (e.g., a centralized or distributed database, and/or associated caches and servers) that store the one or more instructions or data instructions 724. The term “machine-readable medium” shall also be taken to include any tangible medium that is capable of storing, encoding or carrying instructions 724 for execution by the machine and that cause the machine to perform any one or more of the methodologies of the present invention, or that is capable of storing, encoding or carrying data structures utilized by or associated with such instructions 724. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 724 for execution by the machine, and includes digital or analog communications signals or other intangible media to facilitate communication of such software.

Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

What is claimed is:

1. A method, comprising:
retrieving, by one or more processors of a system, reviews for an item from a database;
extracting indicia from the retrieved reviews;
generating a first question based on the indicia extracted from the retrieved reviews;
displaying a first interactive user interface that includes the first question along with an option to provide a response to the first question, the response to the first question corresponding to a review of the item;
generating a second question and an answer to the second question based on the response to the first question received at the first interactive user interface; and
displaying a second interactive user interface that includes:
the second question; and
the answer to the second question.

2. The method of claim 1, wherein the system is associated with a first entity and the database is a third-party database associated with a second entity separate from the first entity.

3. The method of claim 1, wherein the indicia can be one of keywords, phrases, numbers, or text strings.

4. The method of claim 1, wherein a machine learning algorithm extracts the set of indicia by:
determining a frequency of the indicia appearing in the retrieved reviews;
comparing the frequency to a threshold; and
extracting the indicia based on a frequency of the indicia in the retrieved reviews transgressing the threshold.

5. The method of claim 1, wherein the second interactive user interface includes:
an interactive data array, the interactive data array being configured to:
receive a user input, and
cause display of a rating for an attribute of the item in response to the user input; and
a list that lists features of the item, the list of features being based on the indicia appearing in the retrieved reviews.

6. The method of claim 1, wherein the second interactive user interface displays a rating, the rating corresponding to the second question and the rating corresponding to the answer such that the second question and the answer have the same rating.

7. The method of claim 6, wherein the second interactive user interface is configured to receive an input that adjusts the rating.

8. The method of claim 6, wherein the second question and the answer are displayed on the second user interface based on the rating.

9. A method, comprising:
retrieving, by one or more processors of a system, reviews for an item from a database;
providing the reviews for the item to a machine learning algorithm;
extracting, using the machine learning algorithm, indicia within the retrieved reviews, where extracting the indicia comprises:
determining, using the machine learning algorithm, a frequency of the indicia appearing in the retrieved reviews;
comparing, using the machine learning algorithm, the frequency to a threshold; and
extracting, using the machine learning algorithm, the indicia based on a frequency of the indicia in the retrieved reviews transgressing the threshold; and
generating a question based on the indicia extracted from the retrieved reviews.

10. The method of claim 9, wherein the system is associated with a first entity and the database is a third-party database associated with a second entity separate from the first entity.

11. The method of claim 9, wherein the indicia can be one of keywords, phrases, numbers, or text strings.

12. The method of claim 9, further comprising:
causing displaying of a first interactive user interface that includes the question along with an option to provide a response to the question, the response to the question corresponding to a review of the item; and
generating an additional question and an answer to the additional question based on the response to the question received at the first interactive user interface.

13. The method of claim 12, further comprising causing display of a second interactive user interface that includes:
the additional question; and
the answer to the additional question.

14. The method of claim 13, wherein the second interactive user interface is configured to:
display a rating, the rating corresponding to both the additional question and the answer; and
receive an input that adjusts the rating.

15. The method of claim 13, wherein the second interactive user interface displays a rating that corresponds to the additional question and the rating corresponds to the answer such that the additional question and the answer have a same rating where the additional question and the answer are displayed on the second user interface based on the rating.

16. A device, comprising:
a processor; and
memory including instructions that, when executed by the processor, cause the device to perform operations comprising:
retrieving, by one or more processors of a system, reviews for an item from a database;
extracting indicia from the retrieved reviews;
generating a first question based on the indicia extracted from the retrieved reviews;
displaying a first interactive user interface that includes the first question along with an option to provide a response to the first question, the response to the first question corresponding to a review of the item;
generating a second question and an answer to the second question based on the response to the first question received at the first interactive user interface; and
displaying a second interactive user interface that includes:
the second question; and
the answer to the second question.

17. The device of claim 16, wherein the operations further comprise:
determining a frequency of the indicia appearing in the retrieved reviews;
comparing the frequency to a threshold; and
extracting the indicia based on a frequency of the indicia in the retrieved reviews transgressing the threshold.

18. The device of claim 16, wherein the second interactive user interface includes:
an interactive data array, the interactive data array being configured to:
receive a user input; and
cause display of a rating for an attribute of the item in response to the user input;
a list that lists features of the item, the list of features being based on the indicia appearing in the retrieved reviews.

19. The device of claim 16, wherein the second interactive user interface displays a rating, the rating corresponding to the second question and the rating corresponding to the answer such that the second question and the answer have the same rating and the second question and the answer are displayed on the second user interface based on the rating.

20. The device of claim 19, wherein the second interactive user interface is configured to receive an input that adjusts the rating.
